(19) United States
(12) Patent Application Publication
(10) Pub. No.: US 2011/0123971 A1
(43) Pub. Date: May 26, 2011

(54) Electronic Medical Voice Instruction System

(75) Inventors: Robert Berkowitz, Menlo Park, CA (US); Karen Drexler, Los Altos Hills, CA (US); Stephen Dixon Bristow, Los Altos, CA (US); Robert Lewis Anderson, Stanford, CA (US)

(73) Assignee: Medivoce, Inc., Menlo Park, CA (US)

(21) Appl. No.: 12/951,059

(22) Filed: Nov. 21, 2010

Related U.S. Application Data
(60) Provisional application No. 61/262,973, filed on Nov. 20, 2009.

(51) Int. Cl. G09B 5/00

(52) U.S. Cl. 434/308

(57) ABSTRACT

An audible medical information system for a patient or other lay user that is loaded with content by a company or the health care practitioner and can be played at will by the patient and a means for recording information in the audio file. In one embodiment, the system records information in a physical card that the user can have with them without the need for any electronic devices such as a computer or smart phone. Other embodiments may include electronic audio or video files delivered to a computer or smart phone. The audio file can contain up to several minutes of audible information, some of which may be patient specific and some of which may be disease or medication specific. The information may include pre- or post-surgical instructions, information about medications or basic use instructions for medical devices.

The file(s), which can play when a card is opened (note card format) or a button is pressed (credit card or digital format), will repeat the information as the user desires. The audio is in the form of a computer generated and/or pre-recorded human voice, which may be customized for the patient's language of choice and speech patterns, and will be clear and understandable. The voice characteristics may be optimized for persuasive characteristics so this tool can help motivate patient adherence to medical instructions. This system has particular utility for patients who do not speak the same language as the health care practitioner or who do not have the ability to understand the written instructions provided, although the system will be available in convenient form factors for all patients and for those who help with their medical care. Easy access to this information will contribute to improved patient satisfaction and compliance with medical instructions which is expected to improve health outcomes.

### CROSS-REFERENCE TO RELATED APPLICATIONS

This application claims priority to U.S. Provisional Application No. 61/262,973, filed Nov. 20, 2009, entitled “Electronic Medical Voice Instruction System”, which is incorporated by reference herein.

### BACKGROUND OF THE INVENTION

Lack of patient adherence to medical instructions is an enormous problem. The economic impact is huge and the medical system is overburdened with patients who have complications or repeat episodes of illness because doctors' instructions are routinely not followed.
Adherence to (or compliance with) a medication regimen is generally defined as the extent to which patients take medication as prescribed by their health care providers. The word “adherence” is preferred by many health care providers, because “compliance” suggests that the patient is passively following the doctor's orders and that the treatment plan is not based on a therapeutic alliance or contract established between the patient and the physician. Adherence to Medication. Osterberg L M.D., Blaschke T M.D. N Eng J of Med. 2005 August; 353(5):487-497.

Numerous studies track the costs that are directly associated with non-adherence. The focus is often on the problems that occur when patients don't follow through with prescription medications but the issues are numerous, from not monitoring blood glucose levels for people with diabetes to not properly changing dressings after a surgical procedure.
It is estimated that non-compliance to prescribed medications causes nearly 125,000 deaths per year. National Pharmaceutical Council symposium, Therapeutic consequences of noncompliance, 1984: 7-16.
Ten percent of hospital and 23% of nursing-home admissions are linked to non-adherence. National Pharmaceutical Council symposium, Emerging issues in pharmaceutical cost containing, 1992:1-16.
A third of all prescriptions are never filled, and over half of prescriptions that are filled are associated with incorrect administration. Non-adherence directly costs the U.S. health care system $100 billion annually Annual indirect costs exceed $1.5 billion in lost patient earnings and $50 billion in lost productivity. Meta-analysis of trials of interventions to improve medication adherence. Andrew M. Peterson, Liza Takiya, Rebecca Finley (Philadelphia College of Pharmacy) Am J Health-Syst Pharm. 2003 April; 60:657-665.
Compliance with lipid-lowering therapy is poor in clinical practice . . . . As many as 6 out of 10 patients may stop taking statins during the first 6 months following initiation of treatment. Poor compliance has been associated with worse clinical outcome and increased cardiovascular morbidity and mortality. Importantly, statin withdrawal may be even worse compared with not taking statins at all. Increasing adherence rates should become a major concern for physicians. Compliance with lipid-lowering therapy and its impact on cardiovascular morbidity and mortality. Liberopoulos E N, Florentin M, Mikhailidis D P, Elisaf M S. Expert Opin Drug Saf. 2008 November; 7(6):717-25.

There are many contributors to these adherence problems. Doctors are often rushed and studies show that only a few minutes of a physician visit are focused on patient instructions. Many patients are stressed when in a doctor's office and often can't recall exactly what instructions they were given. Add to that the complications of language and literacy barriers and many patients simply do not know what to do even if provided with written instructions. Most written instructions are written in small type, are complex and focus on the things that can go wrong. The intent of this invention is to provide simple, motivational instructions to improve patient satisfaction, adherence and, ideally, outcomes.

One in four Americans is non-white, Hispanic or Native American but fewer that ten percent of those working in health professions represent these minority groups. The elderly, a rapidly growing segment, can present additional challenges for recalling and following medical instructions.
In a study of Medicare patients, striking deficiencies were found in their understanding of critical areas of health care:
   48 percent did not understand written instructions to “take medicine every six hours.”
   68 percent could not interpret a blood sugar level.
   27 percent did not understand “take medicine on an empty stomach.”
   27 percent could not identify their next appointment.
   100 percent could not understand a statement of Medicaid rights written at a 10th grade reading level.
Some patients are unfamiliar with the Western practice of taking long-term medication for chronic illness and with the notion of accepting unpleasant side effects as the price for effective treatment. Source: CULTURAL and GENETIC DIVERSITY in AMERICA: The Need for Individualized Pharmaceutical Treatment. Burroughs V J, MD, Maxey, R W, MD, PhD, Crawley, L M, MD, Levy, R A, PhD. National Medical Association. 2002 (November).

Clearly, there is a need to enhance the understanding for many consumers of health-related information as current practice is not adequate.
An estimated 50% of all asthma patients do not take the medication as prescribed. Numerous interventions have been evaluated in clinical studies, ranging from simple adjustments in the medication regimen to complex multidisciplinary interventions that address health system barriers and communication between patients and health care professionals. Methods to improve patient's adherence: Is there hope? Gillissen A, Juergens U, Busch K. (Leipzig, Deutschland). Dtsch Med Wochenschr. 2008 July; 133(27): 1451-6.

Various attempts have been made to improve patient compliance/adherence. Many doctors and institutions subscribe to services that provide printed patient instruction sheets for various conditions and to prepare and follow up from various procedures. Physicians report that these are helpful but inadequate for most patients. There are numerous devices that are designed to remind patients with alarms to take measurements (such as weight or glucose readings) or to take medication. Some managed care programs have set up periodic calls with nurses to talk to patients about the benefits of proactive management of chronic diseases. This latter approach is very expensive but demonstrates how much money organizations are willing to spend to reduce the even higher costs of noncompliance.

### SUMMARY OF THE INVENTION

During a visit with a health care practitioner (HCP), a patient typically receives verbal instructions about preparing for a medical procedure, following a medication regime or other actions that are required. In the simplest embodiment, the HCP will select a prerecorded device (VoiceCard) from his or her inventory and hand that to the patient to take home. In an alternate embodiment, the HCP will enter some basic information on the computer (this will be part of an electronic medical record system in the future) that will guide what is recorded on the VoiceCard or in an electronic file the patient can access from a device such as a personal computer or phone. The system may automatically print pre-approved instructions and may record an audio message on a chip or card in the HCP office. The audio information is meant to supplement, not replace, the written information. The patient will be able to take home “the doctor's voice” (most likely a computer generated or modified voice, or the prerecorded voice of an actor) and can listen to the message at will until the message ceases to play (in the case of a non-rechargeable battery powered device).

The system will be inexpensive, simple to use for the HCP, patient and other care providers, non-intrusive and not intimidating. It is intended for lay users, not HCPs. The messages will be targeted to the specific disease or treatment required or program to be followed and, optionally, will be personalized for patient characteristics. The product can be sent directly to the patient as a physical or digital product, with the “order” initiated by either the patient directly or the HCP.

The messages to be delivered will be approved by medical personnel where appropriate to provide credibility to both the HCP and the patient/user. The messages may be pre-transcribed and stored in memory within a recording device in the HCP office or digitally stored in servers and transmitted via computer to the HCP, with capability for real-time voice modification applied to the pre-approved messages and on-site rapid down-loading into the VoiceCard's memory.

Alternatively, the message can be sent electronically to the patient to be played on his/her computer or loaded into a personal electronic device such as a smart phone. The messages can also be prerecorded on VoiceCards that are specific to the procedure or drug or program and a selection of VoiceCards can be available at the HCP office, pharmacy or other location to be given or sold to patients.

In another alternative, the HCP can select what will be included on the VoiceCard via a web interface or even a faxed checklist. The VoiceCard can be custom manufactured, including graphics that are professionally printed and the content loaded including the options selected by the HCP and various means for customizing the VoiceCard, including the patient's name and language preference, and shipped directly to the patient's home. This mode of delivery might work well, for example, for a surgery that will take place a number of days following the HCP visit.

Although it is cost prohibitive for a low cost portable device at this time, it is anticipated that future technology will enable portable, disposable video devices. Video can certainly be used in files that are delivered digitally. In this way, the message may be further enhanced by including a demonstration of something such as the proper way to re-bandage a wound or to use a medical device such as a nebulizer. Pre-recorded video files that can be retrieved on a personal computer or smart phone are certainly viable at this time.

This type of information delivery may apply to a broad category of health and wellness topics as well. There could be topics ranging from how to properly move an injured person to methods to distract oneself from cravings for people on weight loss or smoking cessation programs. In general, there is utility when the patient or user moves from one state to another—whether learning about a new disease or device or medication, recovering from a procedure or initiating a new program. Simple, motivational instructions can help make that learning process much easier, improving patient or user satisfaction and, hopefully adherence and outcomes.

### OBJECTS OF THE INVENTION

The object of this invention is communicate and motivate in order to improve adherence with medical/health and wellness-related instructions and increase patient satisfaction. Lack of adherence is closely correlated with poor outcomes, from not completing full courses of antibiotics and having recurrent infections to not following post-surgical instructions resulting in seriously delayed recovery times. A further object of this invention is to reduce poor outcomes and thus decrease the cost of delivering health care.
Multiple variables affecting physicians and patients contribute to nonadherence . . . . Analysis of various patient populations shows that choice of drug, use of concomitant medications, tolerability of drug, and duration of drug treatment influence and prevalence of nonadherence . . . . On average, one third to one half of patients do not comply with prescribed treatment regimens (cardiovascular/hypertension medication) . . . . Medication nonadherence results in a significant burden to healthcare utilization—the estimated yearly cost is $396 to $792 million. Aditionally, between one third and two thirds of all medication-related hospital admissions are attributed to nonadherence . . . . Hypertension affects approximately 72 million adults in the United States, . . . often developing in a cluster with insulin resistance, obesity, and hypercholesterolemia . . . . Medication nonadherence: an unrecognized cardiovascular risk factor. Munger M A, Van Tassell B W, LaFleur J. (University of Utah, Salt lake City, Utah). MedGenMed. 2007 Sep. 19; 9(3):58.

Another object of the invention is to provide a tool for HCPs to augment the instructions they currently provide to people. This will reduce the number of inquiries made by patients who are not sure what they should do after they leave the medical office which will reduce the burden on already understaffed practices while improving the quality of care.

Patient compliance may be improved by means of audio/video messages given to the patient or caregiver following a medical interaction utilizing one or more of the following:
1) The doctor's voice or another live voice.
2) A human voice electronically modified to alter voice factors and to enhance effectiveness, based on Communications Science experiments. Factors include volume, pitch, range and speech rate.
3) An electronic voice that has been optimized to enhance effectiveness, including volume, pitch, range and speech rate.
4) An electronic voice that includes features which closely match those of the patient, including but not limited to gender, accent, primary language, personality, age, education and intelligence.
5) The patient's own voice.

It has been scientifically demonstrated in other fields of endeavor that the qualities of a voice impact the persuasive capabilities of that voice. (Automated phone answering systems and talking global positioning systems are examples where the study of voice qualities has been applied to enhance interactions with users.) By combining expertise in communications, psychology and engineering, we intend to provide an important tool for patients that communicates key information and subtly persuades the patient to follow the instructions for his or her own good. In one preferred embodiment, the incorporation of certain voice qualities and use of positive and motivating language will enhance the audio delivery of medical instructional information.
The human brain rarely makes distinctions between speaking to a machine and speaking to a person. Because humans will respond socially to voice interfaces, designers can tap into the automatic and powerful responses elicited by all voices, whether of human or machine origin, to increase liking, trust, efficiency, learning, and even taking action. Nass, Clifford et al, Wired for Speech, MIT 2005

There are additional situations where audible instructions may be extremely useful, such as in the use of certain medical devices. Some devices, such as Epi-Pens, may only be used occasionally and the original instructions for use misplaced, long forgotten or never learned by the patient who needs to operate the device. In the case of an Epi-Pen, the person with the device may know how to use it but may be incapable (ie severe allergic response) and whoever is nearby may be called into service. Having a simple instruction (press here), an interface (a button to push) and components of a device that can provide audio instruction can be life saving when an untrained user needs to respond quickly. This approach has been incorporated into AEDs (Automatic Electronic Defibrillators) but has not been deployed in inexpensive or disposable devices. The inventions contained herein are geared toward low cost implementation and could be very appropriate where cost is an important consideration.

In another embodiment, having information about the medication name, dosing and any warnings readily available on a pill bottle could save errors, which can be life threatening, when people take the wrong medications alone or in combination. A simple button or buttons on a pill bottle cap can provide the information quickly and accurately, even to those with literacy or vision problems.

This invention is intended to encourage, educate and, perhaps, amuse the patient while improving both the quality of care and the cost of delivering care.

### BRIEF DESCRIPTION OF THE DRAWINGS

FIG. 1—Illustration of the graphics which may be employed on a VoiceCard designed to assist patients who are recovering from an arthroscopic gall bladder procedure.

FIG. 2—Card Physical Appearance—this figure illustrates the appearance of one model of the VoiceCard

FIG. 3—Recording and Use Flow—the figure illustrates the process by which the HCP creates the patient instruction VoiceCard and the patient makes use of it.

FIG. 4—HCP Input—the figure illustrates the process where the HCP creates a voice recording of his/her instructions by use of a mix of customized recordings in his/her own voice and prerecorded generic voice files.

FIG. 5—Local Recording—this block diagram illustrates the hardware and connections to make voice recordings into a VoiceCard in the HCP office.

FIG. 6—Remote Recording—this figure illustrates the process by which the HCP makes a voice recording that is transmitted to a remote server, is captured by the remote server, and the resulting voice file is downloaded into the VoiceCard via a digital connection with the HCP's PC. It also illustrates the process by which the HCP makes a voice recording that is transmitted to a remote server, is captured by the remote server, and the resulting voice file is downloaded directly into the VoiceCard via a telecommunications link directly to the VoiceCard without the need to pass through the HCP's PC.

FIG. 7—Voice File Created at Server—this figure illustrates the process by which the HCP can select from preprogrammed generic voice files stored in a remote server that are subsequently downloaded into the VoiceCard.

FIG. 8—Local Recording Site (local voice recording combined with generic files from a server)—this figure illustrates the process by which the HCP can select from preprogrammed generic voice files stored in a remote server, combine them with a voice instruction in his/her own voice and subsequently download the combined voice instructions into the VoiceCard.

FIG. 9—Card Block Diagram of the electrical components that are contained in the VoiceCard.

FIG. 10—Graphic Instruction Creation Flow—this illustrates the process by which the HCP can select pre-stored graphics to be placed on the VoiceCard and combine them with any custom notes that she/he wants to graphically communicate to the patient.

FIG. 11—Pill Bottle Cap Alternative Embodiment—this figure illustrates an alternative embodiment of this invention that has its electronic portion incorporated into a pill bottle cap and the graphic portion incorporated in a label on the pill bottle.

### DETAILED DESCRIPTION OF THE INVENTION

This novel system allows a HCP to provide an alternative method of delivering care instructions to patients. In the case of surgical patients, the patient is naturally distracted by the pending surgery before the operation and is under the influence of various medications and pain relievers after the procedure. There exists a need to provide for better adherence with the HCP instructions. This invention provides for the provision of patient instructions in a combined voice (or video) and graphical format that can be personalized for the patient. The instructions are available for the patient to get an audible instruction whenever she/he needs confirmation of what she/he might have heard or has a worry and needs instructions about what to expect and how to handle it. Alternately, the patient (or a friend or family member) may procure the product at retail channels or online for their own use or as a gift for someone who might benefit.

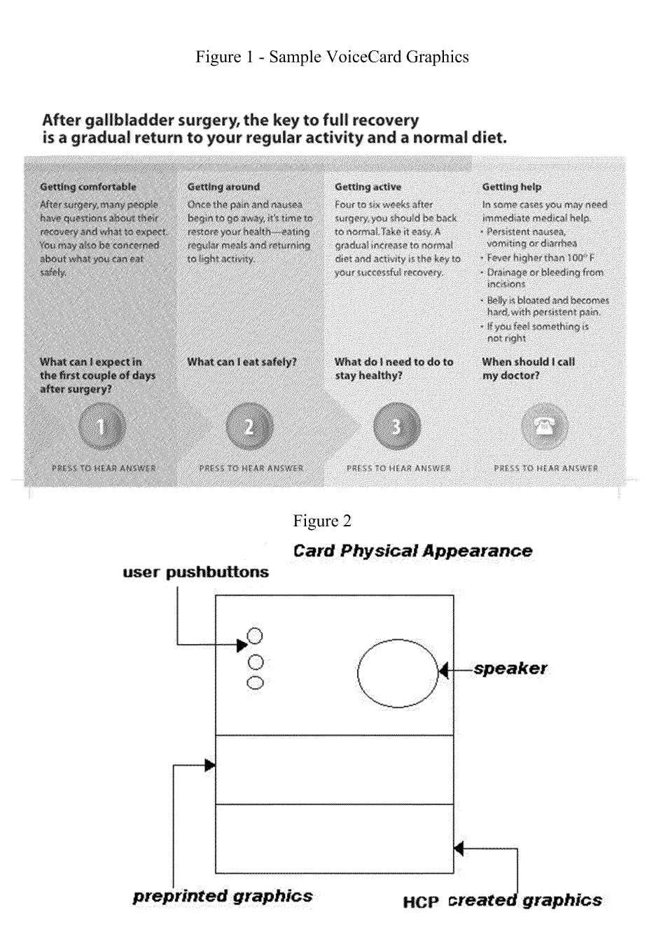

FIG. 1 shows the graphics for a VoiceCard that was developed to patients who are recovering from an arthroscopic gall bladder removal procedure. The VoiceCard can be a physical object or the graphics can accompany audio files as part of a digital product for people who wish to access the information on a computer or other electronic device.

FIG. 2 illustrates one possible appearance of the VoiceCard. Shown are the user push buttons, the speaker and areas for pre printed and/or custom HCP created graphics. This figure is meant to be illustrative only and is not meant to define the actual location of parts or their appearance as part of the VoiceCard. Note that the VoiceCard may be entirely manufactured and shipped to the HCP or patient/care giver or to a distributor (medical office, retail pharmacy, etc.) as a finished part. The HCP could select the most appropriate VoiceCard from inventory, such as for a person undergoing hernia or gall bladder surgery. A digital version of the VoiceCard can follow a similar process of creation (using combinations of custom and standard graphics and recordings) and the various parts of the VoiceCard may be accessed via electronic devices.

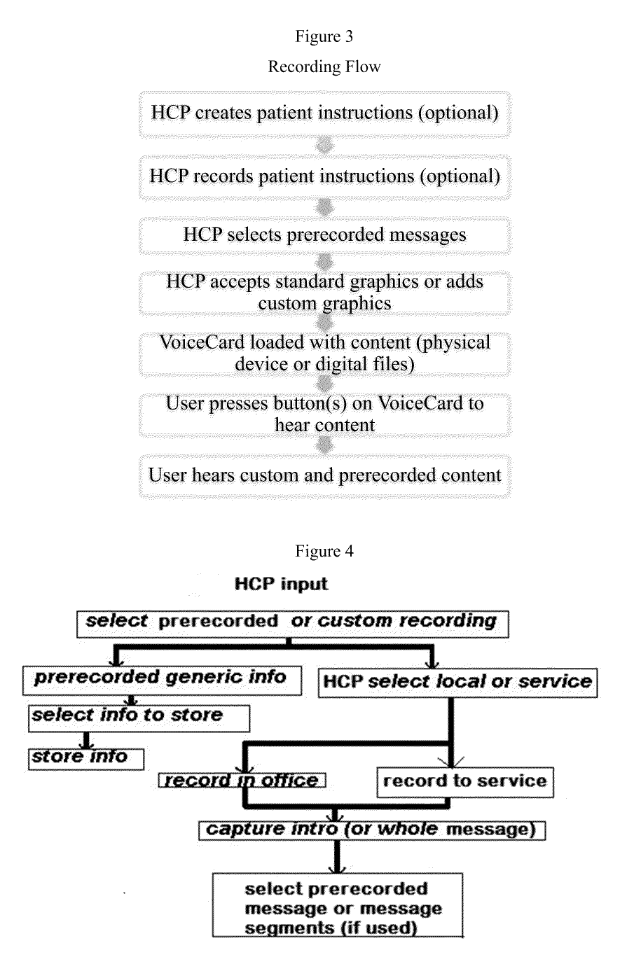

FIG. 3 illustrates the steps of the process for one embodiment of the invention. The HCP first decides what information is appropriate for the patient. The HCP can optionally record a personal instruction to the patient in a voice that is familiar to the patient and will comfort and motivate the patient. The delivery mechanism to the patient is a device that may be in the form of a VoiceCard that includes generic graphical information appropriate to the procedure that the patient has undergone or new medication that is prescribed and may include custom graphics that the HCP has selected to also be printed to illustrate particular items about which that patient or a caregiver should be aware. The patient can view the graphics printed on the VoiceCard as well as select to hear the HCP's personalized instructions and/or the appropriate generic instructions that the HCP has recorded and/or selected. These instructions can advantageously be recorded in the language with which the patient is most familiar. Alternately, the voice file(s) created can be accessed on a personal computer or smart phone.

The HCP has the option of selecting from a number of pre-recorded voice files that may be appropriate to describe the message that the HCP wishes to deliver to the patient. These files may be stored locally on the HCP's own computer system or may be accessed via a link to a server. The server may be located in his/her office complex or may be located at another site that can be reached by an Internet or other telecommunications link.

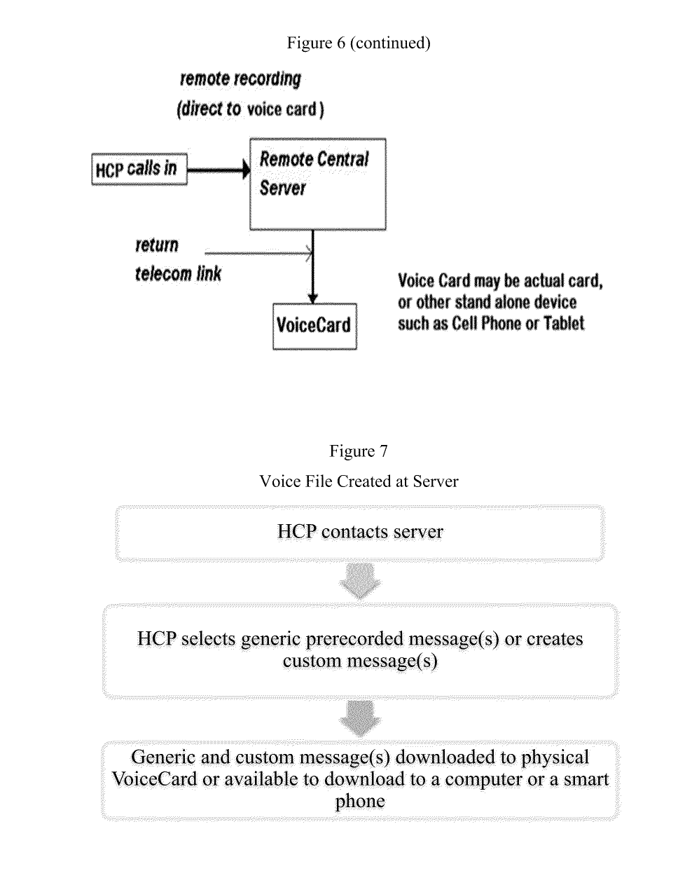

If the HCP chooses to make use of a locally pre-stored voice file he/she needs only select from a variety of choices presented, connect the VoiceCard to the USB port of his/her computer and select to download the voice file[s]. The process of using pre-recorded instructions stored in the service center is illustrated in FIG. 6. A similar process would be used if the generic voice files are stored in the HCP's own computer. The HCP may also elect to make a complete or introductory recording in his/her own voice. The HCP may make use of the sound card and voice recorder that is built into his/her office computer for convenience. The HCP may also make use of a recording service that is remotely located. The advantage of a remote service is that the HCP need only phone the remote service center. By means of a normal voicemail-like recording and editing touch tone control the HCP may simply record a greeting or the whole message. The service center may provide audio processing to decrease remote noise and increase the intelligibility of the recording.

If the HCP does not want to record the generic messages she/he may advantageously select from pre-recorded generic messages that could either be stored on his/her office PC or at the remote service center. This information could be addressed via a graphical interface on the PC or by means of numeric touch-tone entry to the data center.

After the recordings are made they may be downloaded into the VoiceCard by a variety of methods. They can also be made available for the patient or caregiver to access through a personal computer or cellular phone.

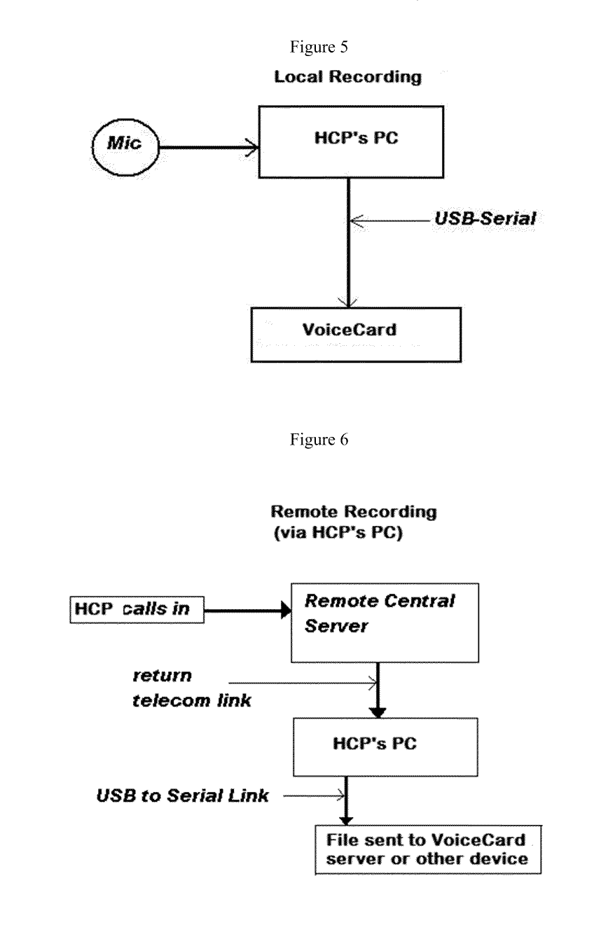

FIG. 5 illustrates in more detail the connections made to the PC in the HCP office to make local recordings. The microphone is plugged into the sound card or microphone jack built into the HCP's PC. By means of the Microsoft Windows Recorder program that is built into the typical Windows operating system or by means of any number of commercially available sound recording and processing programs the HCP can record the voice message that he/she wishes. The VoiceCard is connected to the PC by means of a serial cable. Illustrated in this figure is a USB connection, but other protocols can be used to load information into the VoiceCard such as I2C or SPI that are well known in the art. In a preferred embodiment the VoiceCard's memory may appear to the PC as a remote memory device to which the HCP need only transfer the voice file.

FIG. 6 further illustrates the process by which the HCP can make use of a service center to record his/her messages. As shown the HCP may dial into the service center by means of any common telephonic technology such as dial up lines, cellular service or a computer telephonic link such as Skype. Once connected to the service center the HCP may control the process by means of touchtone or voice commands to create a voice recording with which the HCP is happy. Audio processing of the voice recording may be done by the HCP's discrete selection or automatically to alter the frequency response, remove noise, remove excessive silences, optimize audio levels, etc. The actual processing done will be dependent upon the implementation of the software in the service center.

Once the voice file is complete and acceptable, the service may then connect to the HCP's PC via a telecom linkage that might be dial up analog, DSL or cellular modem. Once the link is established the software in the service center and the HCP's PC interact to download the desired voice file[s] from the service center into the HCP's PC. The programs to allow this download and remote control of the HCP's PC may be a custom software package or may involve the use of commercially available remote control and file transfer programs like “Laplink for Windows” by the Traveling Software Company. Once the file is loaded into the HCP's PC it is then transferred to the VoiceCard by the process described earlier. Alternately, the service center can upload the files to the internet and users (patients, care givers) can access the files via personal computers or cellular phones.

In another embodiment of the system a telecommunications link is build directly into the card. This link, also illustrated in FIG. 6, would allow the remote service center to directly download into the VoiceCard without the need for any connection to the HCP's PC. While this method may involve more cost in the VoiceCard, this extra cost may be offset by increased customer satisfaction in that the HCP's PC need not have any software loaded into it and will have no potential vulnerability to being accessed by nefarious parties trying to hack into the HCP's computer via the remote telecommunications link. The actual telecommunication link may be by means of a DSL, WiFi, Ethernet, dial up or cellular modem. In the preferred embodiment the final link to the VoiceCard would be by means of a wireless protocol that would eliminate the need for any cable connection to the VoiceCard.

The recording system described allows the HCP to be able to create the desired messages without having to use a computer. The process of combining a voice recording in the HCP's own voice with generic voice instructions is illustrated in FIG. 7. While FIG. 7 illustrates the case where the generic instructions and the recording of a HCP's custom information is done via the use of a remote service center, a similar process can be done at the HCP office where the HCP would make the local voice recording onto his/her own computer with a microphone and would select from pre-recorded generic voice instructions stored on his/her office PC, as shown in FIG. 8.

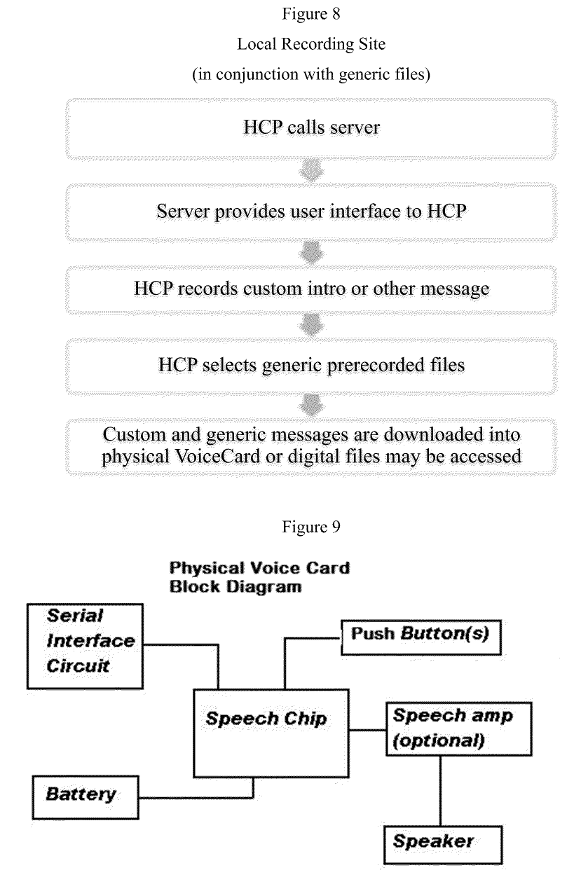

The internal parts of the VoiceCard are illustrated in FIG. 9. In the preferred embodiment a single chip speech chip incorporates internal control circuitry, a speech data storage array, I/O interface circuits, power regulators, and audio output circuits. A commercial chip illustrative of this sort of chip is the 17xxx series of speech chips supplied by Nuvoton, a Taiwan based company with offices on First Street, San Jose, California. Details of the internal design and operations of these chips can be found via their parent company's web site of www.winbond.com.tw. The speech chip is mounted on a printed circuit board with may incorporate connectors for serial interface. The power supply may be a set of two or more batteries that are either connected to the PCB via wires from a battery pack in the case of AA or AAA batteries being used. Alternatively button cells can be mounted into clips that are part of the actual PCB. In one embodiment there are two or more user accessible switches normally used. When one button is pressed, for example, a message describing what to expect if things proceed as projected is played by the speech chip. When another button is pressed a message describing what to do in case the patient is encountering difficulties is played. These buttons may be implemented by means of conductive patterns on the printed circuit board (PCB) that are bridged when a rubber button with a conductive carbon contact is pressed against the PCB. Alternatively the switches may be mounted at a distance from the PCB and connected to the PCB by means of wires or flexible circuits. The audio transducer may be of the normal voice coil movement type. Other speaker types such as piezo electric speakers may also be used. These speakers, like the push buttons and batteries, may be mounted on the PCB or at another location within the VoiceCard. Depending on the speaker type used, the volume level desired and the audio output capability of the speech chip an audio amplifier may be optionally mounted on the PCB if needed. Not shown on the figure is an optional power switch that may be used to eliminate battery drain and maximize battery life when the VoiceCard is not used for an extended period. For example, there may be an extended period of time between the manufacture of the card and its first use by a HCP or patient. Such a power switch can be accomplished in a variety of well-known means such as a discrete power switch or a plastic film tab that prevents the batteries from making full electrical contact until the film tab is pulled out of the product.

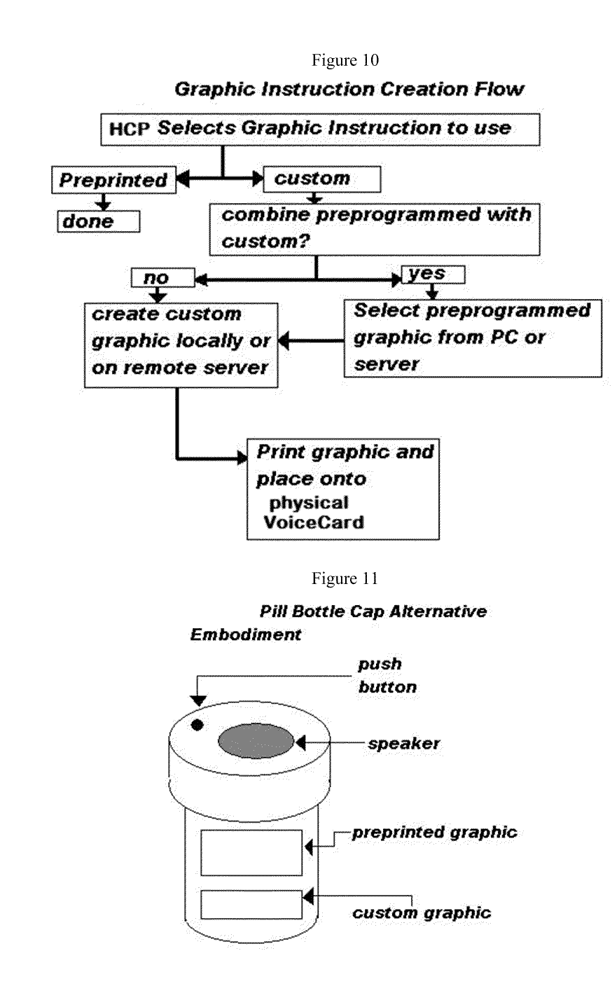

FIG. 10 illustrates the flow by which the HCP may create the graphics for the VoiceCard. In the case that the HCP wants to have custom content, in one preferred embodiment, he/she can access a set of complete prepared graphics from a menu of choices in various languages and specific to particular procedures. Once the HCP has made his/her selection he/she need only use his/her office PC to print out the label. The HCP may also elect to create his/her own patient specific text and select graphical elements. Prewritten instructions stored in the server or in the HCP's own PC may be combined with text into a complete custom graphical instruction. After the HCP prints the custom graphical instructions they can be placed onto the VoiceCard in any of the methods previously discussed.

FIG. 11 illustrates an alternative physical arrangement of the parts. In this case the electronics are mounted as part of a pill bottle cap. The custom and preprinted graphics in this embodiment at applied to the pill bottle itself This alternative embodiment has the advantage of making the vocal and graphic instructions available to the patient whenever the patient is using any prescribed medicine. The limited number of buttons used in this patient information system allow make it easier to fit the required push buttons in the pill bottle cap.

The VoiceCard format has the advantage of allowing for a much larger area for graphical instructions and in being appropriate for patient use even if no medicine is prescribed after the procedure. The VoiceCard format also allows for a much larger speaker to be mounted that allows for increased volume and fidelity.

The physical VoiceCard format may also provide the space to allow for an acoustic cavity and integral speaker porting to optimize the sound quality. The use of messages in the HCP's own voice and professionally pre-recorded generic messages and the attention to speaker quality is intended to minimize any patient reaction that the VoiceCard is an inexpensive greeting card instead of the important medical information tool it was designed to be. This will encourage patients to keep and use the VoiceCard, providing ongoing value.

As mentioned previously the information presented by the VoiceCard is both in audio (and/or video) and graphical form. In the simplest embodiment the graphics printed on the VoiceCard are preprinted generic graphics and instructions. At the expense of creating more SKUs or versions of the VoiceCard to stock the preprinted graphics may be specific to a language or a procedure.

An alternative implementation that combines preprinted graphics and instructions with graphics and instructions that are language, patient, and/or procedure specific is to create VoiceCards with custom graphics and instructions. These custom graphics may take all the graphics space on the VoiceCard or could share the graphical area of the VoiceCard with preprinted graphics areas. The custom graphics may be printed directly on the VoiceCard, printed on an appliqué that can be applied like a label to the VoiceCard, or on a card that could be inserted into a clear pocket that is part of the VoiceCard. Such pockets are well known in the paper binder industry. Use of such pockets to contain the custom graphics has the advantage of being able to use the HCP's existing PC printer to create the insert card. The other techniques may not be appropriate for the HCP who does not want to invest in a high quality printer to print directly onto the VoiceCard. The appliqué or label method could make use of the HCP's existing PC printer, but requires skill and care to apply a label without wrinkles or skew. In an embodiment that supports video (with a screen of some variety), the graphical information may include animation, live video and/or static images and words strung together to create a visual presentation. The graphics could provide appropriate imagery to accompany the words or a direct video or slide-based demonstration of a procedure such as performing a glucose test or bandaging a wound.

What we claim:

1- A system for providing a lay user with distinct audio and/or video medical or health-related instructions, including one or more pre-recorded audio or video files.

2- A portable, dedicated device which provides a lay user with access to audio or video-based medical or health-related instructions, including a user interface, a memory containing recorded files, graphical information and speaker and, if video is supported, a screen.

3- A system of claim 1 wherein the pre-recorded audio or video files and associated graphics are built into applications that can be loaded onto cellular phones or computing devices such as personal computers or tablets or downloaded or accessed directly from the Internet.

4- A system of claim 1 wherein the pre-recorded audio files are may be accessed by calling a specific number and using sequences of numbers to hear the messages of interest.

5- A system of claim 1 wherein the pre-recorded audio or video files and graphical information are provided as attachments to email messages.

6- A system of claim 2 wherein the graphical information is provided by one or more of the following means: printed instructions on the device, an electronically updateable display medium, an LCD display, or an electronic ink display such as that used on the Amazon Kindle® product.

7- A system of claim 1 wherein the graphical information includes animation, line drawings, photographs or other design elements.

8- A system of claim 2 providing medical or health-related instruction files, containing medical or health-related instructions and information that can allow the user to select prerecorded medical information files by physical means (such as numeric pads or binary switches) or electrical or electromagnetic means (such as the use of magnetic strips, RFID or voice recognition).

9- A system of claim 2 wherein the instruction files and/or graphics have been specifically selected by the health care provider or end user, are loaded by the manufacturer into a portable device and shipped directly to the end user.

10- A system of claim 1 wherein the instruction files and/or graphics have been specifically selected by the health care provider or end user and are made available as digital files that can be accessed via a personal computer or cellular device.

11- A system of claim 2 wherein the instruction files comprising audio recordings made at the health care provider's office and/or prerecorded messages available on a server are loaded into a portable device at the health care provider's office after the shipment of the device from the manufacturer to the health care provider's office.

12- A system of claim 1 wherein the instruction files comprising audio recordings made at the health care provider's office and/or prerecorded messages available on a server comprise a set of digital files that can be accessed via computer or cellular device.

13- A system of claim 1 wherein some or all of the audio recording is in the health care provider's own voice and such recording is made locally in the provider's office.

14- A system of claim 13 wherein some or all of the audio recording is done at the health care provider's office by means of a telephone link to a remote service that can record and process such information.

15- A system of claim 1 wherein the medical or health-related instructions have been recorded into a device by means of a transfer of non-audio computer information.

16- A system of claim 15 wherein the instruction files are delivered in one or more of the following ways: via the Internet, by wireless means, via a direct cellular, text or wifi connection to the device on which the user will access them, via a link to a hand held wireless device such as a cell phone or via a tablet or computer that delivers the information via a relatively short-range link.

17- A system of claim 15 wherein the connection is made by one of the following means: optical, short range RF, or acoustic or mechanical vibration transference.

18- A system of claim 15 wherein the instruction files have been provided by means of a separate memory storage element that can be coupled to the device on which the end user will access the files, which might optionally include a physical memory card that can be inserted into the device on which the end user will access the files or a wireless short range linked memory element that does not need physical coupling but instead institutes a short-range linkage without physical contact.

19- A system of claim 1 where in the medical or health-related instruction files that are used or offered for selection to the user are selected based on previously or concurrently indicated personal information such as gender, age or language preference information or customization is created based on same.

20- A system of claim 1 wherein a process is used to select information that is optimized for the user based on responses from the user which may further identify the most appropriate prerecorded files of audio information, or may use derived information to better customize the audio files based upon factors such as the end user's accent, tone, volume, pitch, pitch range and rate of reading.

21- A system of claim 1 wherein the instruction files are customized based upon parameters that are related to the patient's medical, health or recovery status, including but not limited to the time that has elapsed from a medical procedure or treatment or initiation of a program or the time of day such that the user may get information specific to the time of day.

22- A system of claim 2 wherein there is a memory for holding voice or video files that may be recorded into via a socket that can receive a source of recording information.

23- A system of claim 2 wherein there is a severable connection between an external source of information and the system, such connection may optionally be severed by physical manipulation of the link in a manner that includes twisting or bending a link until it breaks, or may be severed by physically pulling on the connection cable or a tab associated with it in a manner akin to that used to disable microphone recording in electronic greeting cards.

24- A portable device containing a user interface, means for displaying graphical information, speaker and memory that makes use of the physical housing to enhance sound quality.

25- A system of claim 24 which includes one or more of the following: a speaker or speakers mounted in a substantially flat card form that provides for audio porting of the back of the speaker pressure waves in a bass reflex manner, passive Whizzer cones or surfaces to allow the pressure waves created by the back side of the speaker cone(s) to be used to excite a thin membrane on the front of the portable device, and/or the use of the thickness of the device itself to provide audio porting of the pressure produced by a speaker to the periphery of the portable device.

26- A system of claim 2 wherein the front surface is embossed to allow for easy location of selected button locations by tactile feel.

27- A system of claim 2 wherein the device has been treated to allow for some or all of the graphics to be located or read in the dark, including but not limited to the printed graphics having at least some portions printed in luminescent paint, the acuatable buttons have illumination sources such as LEDs located adjacent or co-axially with them, the illumination source is pulsed and is not continuously illuminated, and/or there is a light source internal to the device that may be seen through the printed graphics in low light, such that the locations of the buttons might be thus illuminated.

28- A system as in claim 27 where the illumination source is composed of a radioactive /phosphor combination such as used in the Luminox® watches.

29- A system as in claim 2 where the actuatable buttons include piezo electric elements such that surface of the button may buzz or pulse to allow the user to locate the button in the dark without the requirement of illumination.

30- A system of claim 2 wherein the portable instruction device may be built into the cap of a pill bottle.

31- A system of claim 2 wherein the portable instruction device may be built into medical devices such as nebulizers and home glucose monitoring equipment.
